(19) United States
(12) Patent Application Publication
(10) Pub. No.: US 2025/0272870 A1
(43) Pub. Date: Aug. 28, 2025

(54) ELECTRONIC APPARATUS, IMAGE PROCESSING METHOD, AND STORAGE MEDIUM

(71) Applicant: CANON KABUSHIKI KAISHA, Tokyo (JP)

(72) Inventor: YUTA KAWAMURA, Kanagawa (JP)

(21) Appl. No.: 19/060,566

(22) Filed: Feb. 21, 2025

(30) Foreign Application Priority Data
Feb. 27, 2024 (JP) 2024-027866

(51) Int. Cl. G06T 7/70; G06T 7/50; G06V 10/82; H04N 23/611

(52) U.S. Cl. CPC G06T 7/70; G06T 7/50; G06V 10/82; H04N 23/611; G06V 2201/07

(57) ABSTRACT

An electronic apparatus comprises: a first detection unit that detects one or more subjects from any of images obtained by repeatedly performing shooting; a second detection unit that detects a predetermined object from the image from which the subject/subjects are detected; a determination unit that determines a reliability indicating a degree of possibility of a subject being a main subject based on a posture of each subject detected by the first detection means; an adjustment unit that adjusts the reliability based on a difference between information about a distance to each of the subjects in a depth direction and information about a distance to the object in a depth direction; and a decision unit that decides, based on the reliability adjusted by the adjustment unit, one of the subject/subjects detected by the first detecting unit as a main subject.

### BACKGROUND OF THE INVENTION

### Field of the Invention

The present invention relates to an electronic apparatus, an image processing method, and a storage medium, and more particularly to a technique for determining a main subject in a captured image.

### Description of the Related Art

Conventionally, in continuous shooting in which a plurality of shots are taken in succession or in moving image shooting, when shooting a plurality of detected moving subjects by an image capturing apparatus, a main subject is determined from the plurality of subjects, and the determined main subject is kept in focus. As a method for determining the main subject, Japanese Patent Laid-Open No. 2018-66889 discloses a method for detecting a subject (object) and a face to be tracked, setting the main subject based on the position and movement of the tracking target and the position of the face, and adjusting the focus on the set main subject.

However, in the method disclosed in Japanese Patent Laid-Open No. 2018-66889, a subject whose face has not been detected cannot be set as the main subject. Therefore, for example, if a subject intended by a photographer is facing backward, there is a possibility that an unintended subject will be determined to be the main subject and continue to be focused on.

### SUMMARY OF THE INVENTION

The present invention has been made in consideration of the above situation, and in a case where a plurality of different subjects are detected, it is possible to determine the subject that is closest to the photographer's intention as the main subject.

According to the present invention, provided is an electronic apparatus comprising one or more processors and/or circuitry which function as: a first detection unit that detects one or more subjects from any of images obtained by repeatedly performing shooting; a second detection unit that detects a predetermined object from the image from which the subject/subjects are detected; a determination unit that determines a reliability indicating a degree of possibility of a subject being a main subject based on a posture of each subject detected by the first detection unit; an adjustment unit that adjusts the reliability based on a difference between information about a distance to each of the subjects in a depth direction and information about a distance to the object in a depth direction; and a decision unit that decides, based on the reliability adjusted by the adjustment unit, one of the subject/subjects detected by the first detecting unit as a main subject.

Further, according to the present invention, provided is an electronic apparatus comprising one or more processors and/or circuitry which function as: a first detection unit that detects one or more subjects from any of images obtained by repeatedly performing shooting; a second detection unit that detects a predetermined object from the image from which the subject/subjects are detected; a decision unit that decides one of the subject/subjects detected by the first detection unit as a main subject based on a posture of each subject detected by the first detection unit and a difference between information about a distance to each subject in the depth direction and information about a distance to the object in the depth direction.

Furthermore, according to the present invention, provided is an electronic apparatus comprising one or more processors and/or circuitry which function as: a first detection unit that detects one or more subjects from any of images obtained by repeatedly performing shooting; a second detection unit that detects a predetermined object from the image from which the subject/subjects are detected; an acquisition unit that acquires information regarding a distance in the depth direction to each subject detected by the first detection unit and information about a distance in the depth direction to the object; a determination unit that uses machine learning to determine a reliability indicating a degree of possibility of a subject being a main subject based on a posture of each subject; and a decision unit that decides one of the subject/subjects detected by the first detection unit as a main subject based on the reliability, wherein the determination unit uses training data optimized by using information about the distance to the main subject previously acquired by the acquisition unit in the machine learning.

Further, according to the present invention, provided is an image processing method comprising: detecting one or more subjects from any of images obtained by repeatedly performing shooting; detecting a predetermined object from the image from which the subject/subjects are detected; determining a reliability indicating a degree of possibility of a subject being a main subject based on a posture of each detected subject; adjusting the reliability based on a difference between information about a distance to each of the subjects in a depth direction and information about a distance to the object in a depth direction; and deciding, based on the adjusted reliability, one of the detected subject/subjects as a main subject.

Further, according to the present invention, provided is an image processing method comprising: detecting one or more subjects from any of images obtained by repeatedly performing shooting; detecting a predetermined object from the image from which the subject/subjects are detected; determining one of the detected subject/subjects as a main subject based on a posture of each detected subject and a difference between information about a distance to each subject in the depth direction and information about a distance to the object in the depth direction.

Further, according to the present invention, provided is an image processing method comprising: detecting one or more subjects from any of images obtained by repeatedly performing shooting; detecting a predetermined object from the image from which the subject/subjects are detected; acquiring information regarding a distance in the depth direction to each detected subject detected and information regarding a distance in the depth direction to the object; determining a reliability indicating a degree of possibility of a subject being a main subject based on a posture of each subject by using machine learning; and deciding one of the detected subject/subjects as a main subject based on the reliability, wherein training data optimized by using information about the distance to the main subject previously acquired is used in the machine learning.

Further, according to the present invention, provided is a non-transitory computer-readable storage medium, the storage medium storing a program that is executable by the computer, wherein the program includes program code for causing the computer to function as an electronic apparatus comprising: a first detection unit that detects one or more subjects from any of images obtained by repeatedly performing shooting; a second detection unit that detects a predetermined object from the image from which the subject/subjects are detected; a determination unit that determines a reliability indicating a degree of possibility of a subject being a main subject based on a posture of each subject detected by the first detection means; an adjustment unit that adjusts the reliability based on a difference between information about a distance to each of the subjects in a depth direction and information about a distance to the object in a depth direction; and a decision unit that decides, based on the reliability adjusted by the adjustment unit, one of the subject/subjects detected by the first detecting unit as a main subject.

Further, according to the present invention, provided is a non-transitory computer-readable storage medium, the storage medium storing a program that is executable by the computer, wherein the program includes program code for causing the computer to function as an electronic apparatus comprising: a first detection unit that detects one or more subjects from any of images obtained by repeatedly performing shooting; a second detection unit that detects a predetermined object from the image from which the subject/subjects are detected; a decision unit that determines one of the subject/subjects detected by the first detection unit as a main subject based on a posture of each subject detected by the first detection unit and a difference between information about a distance to each subject in the depth direction and information about a distance to the object in the depth direction.

Further, according to the present invention, provided is a non-transitory computer-readable storage medium, the storage medium storing a program that is executable by the computer, wherein the program includes program code for causing the computer to function as an electronic apparatus comprising: a first detection unit that detects one or more subjects from any of images obtained by repeatedly performing shooting; a second detection unit that detects a predetermined object from the image from which the subject/subjects are detected; an acquisition unit that acquires information regarding a distance in the depth direction to each subject detected by the first detection unit and information regarding a distance in the depth direction to the object; a determination unit that uses machine learning to determine a reliability indicating a degree of possibility of a subject being a main subject based on a posture of each subject; and a decision unit that decides one of the subject/subjects detected by the first detection unit as a main subject based on the reliability, wherein the determination unit uses training data optimized by using information about the distance to the main subject previously acquired by the acquisition unit in the machine learning.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram illustrating a functional configuration of an image capturing apparatus according to an embodiment of the present invention.

FIG. 2 is a block diagram illustrating a functional configuration of a main subject determination unit according to a first embodiment.

FIG. 3 is a flowchart of main subject determination processing according to the first embodiment.

FIGS. 4A and 4B are conceptual diagrams of information acquired by a posture acquisition unit and an object detection unit according to the first embodiment.

FIG. 5 is a diagram illustrating an example of the structure of a neural network according to the first embodiment.

FIG. 6 is a diagram explaining an acquisition method in a depth information acquisition unit according to the first embodiment.

FIG. 7 is a conceptual diagram of information acquired by the depth information acquisition unit for each subject and by the depth information acquisition unit for an object according to the first embodiment.

FIG. 8 is a diagram illustrating a graph relating to an adjustment method of a reliability adjustment unit according to the first embodiment.

FIG. 9 is a block diagram illustrating a functional configuration of a main subject determination unit according to a second embodiment.

FIG. 10 is a flowchart of main subject determination processing according to the second embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

In the following embodiment, the present invention will be described as being implemented in an image capturing apparatus such as a digital camera, but the present invention can be applied to any electronic apparatus that can be equipped with a subject detection function and an image capturing function. Such electronic apparatuses include image capturing apparatuses, as well as computer devices (personal computers, tablet computers, media players, PDAs, etc.), mobile phones, smartphones, game consoles, robots, drones, drive recorders, etc. These are merely examples, and the present invention can be applied to other electronic apparatuses.

### First Embodiment

### Configuration of Image Capturing Apparatus

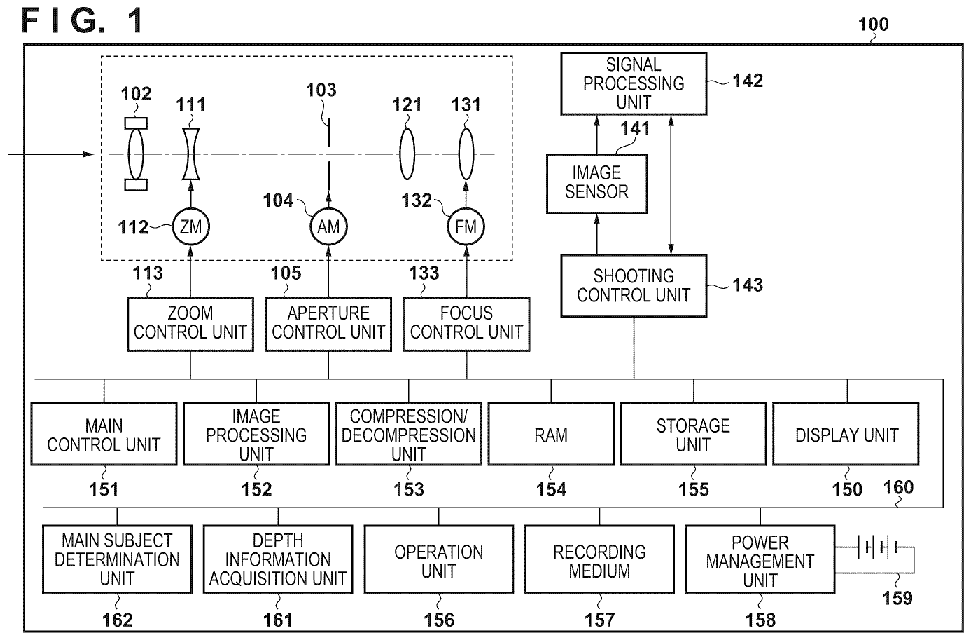

FIG. 1 is a block diagram illustrating an example of a functional configuration of an image capturing apparatus 100 according to the present embodiment. The image capturing apparatus 100 is capable of capturing and recording moving images and still images. The functional blocks in the image capturing apparatus 100 are connected to each other via a bus 160 in a communication-enabling manner. The operation of the image capturing apparatus 100 is realized by a main control unit 151, which is composed of a central processing unit (CPU) or the like, executing a program and controlling each functional block.

An imaging lens 101 has a first fixed lens group 102, a zoom lens 111, an aperture 103, a second fixed lens group 121, a focus lens 131, a zoom motor 112, an aperture motor 104, and a focus motor 132. The first fixed lens group 102, the zoom lens 111, the aperture 103, the second fixed lens group 121, and the focus lens 131 constitute an imaging optical system. For illustrative convenience, the first fixed lens group 102, the zoom lens 111, the second fixed lens group 121, and the focus lens 131 are each represented by a single lens, but each may be composed of a plurality of lenses. The imaging lens 101 may be configured as a detachable interchangeable lens.

An aperture control unit 105 controls the operation of the aperture motor 104 that actuates the aperture 103, and changes the opening diameter of the aperture 103. A zoom control unit 113 controls the operation of the zoom motor 112 that actuates the zoom lens 111, and changes the focal length (angle of view) of the imaging lens 101.

A focus control unit 133 calculates a defocus amount and defocus direction of the imaging lens 101 based on a phase difference between a pair of focus detection signals (image A and image B) obtained from an image sensor 141. The focus control unit 133 then converts the defocus amount and defocus direction into an actuation amount and actuation direction of the focus motor 132. Based on these actuation amount and actuation direction, the focus control unit 133 controls the operation of the focus motor 132 and actuates the focus lens 131 thereby controlling the focus state of the imaging lens 101. In this way, the focus control unit 133 performs autofocus detection (AF) using a phase difference detection method.

Note that the AF method is not limited to the phase difference detection method. For example, the focus control unit 133 may perform AF using a contrast detection method based on a contrast evaluation value obtained from an image signal obtained from the image sensor 141.

An image of a subject formed on the imaging plane of the image sensor 141 by the imaging lens 101 is converted into an electric signal (image signal) by photoelectric conversion elements in a plurality of pixels arranged in the image sensor 141. In this embodiment, the image sensor 141 has pixels arranged in a matrix of m rows in the horizontal direction and n columns in the vertical direction (m and n are multiples), and each pixel is provided with a plurality of photoelectric conversion elements (photoelectric conversion regions) sharing one microlens. Note that here, it is assumed that two photoelectric conversion elements are provided, and a normal image can be obtained by adding the outputs (A signal and B signal) of these two photoelectric conversion elements. In addition, two images having parallax can be obtained by handling the outputs of the two photoelectric conversion elements individually. In the following description, a signal obtained by adding the outputs of the two photoelectric conversion elements is referred to as an image signal, and an image based on the image signal is simply referred to as an image. Further, the outputs of the two photoelectric conversion elements handled individually are referred to as a pair of parallax image signals, and the images based on the pair of parallax image signals are referred to as an A image and a B image, for distinction.

A shooting control unit 143 controls the reading of signals from the image sensor 141 in accordance with instructions from the main control unit 151. Note that, from each pixel, the A signal and the B signal may be read out separately, or either the A signal or the B signal, and an A+B signal obtained by adding the A signal and the B signal, may be read out, as long as an image signal and a pair of parallax image signals are ultimately obtained.

The signal read out from the image sensor 141 is supplied to a signal processing unit 142, which generates an image signal and a pair of parallax image signals. Then, in the signal processing unit 142, signal processing such as noise reduction processing, A/D conversion processing, and automatic gain control processing is performed, and the resultant signals are output to the shooting control unit 143. The shooting control unit 143 stores the image signal and the pair of parallax image signals received from the signal processing unit 142 in a random access memory (RAM) 154.

An image processing unit 152 applies a predetermined image processing to the image signal stored in the RAM 154. The image processing applied by the image processing unit 152 includes, but is not limited to, so-called development processing such as white balance adjustment processing, color interpolation (demosaic) processing, and gamma correction processing, as well as signal format conversion processing and scaling processing. In addition, the image processing unit 152 can also generate information on luminance of a subject for use in automatic exposure control (AE). Information on a specific subject area is supplied from a main subject determination unit 162 and may be used, for example, for white balance adjustment processing. In addition, in a case of performing AF using a contrast detection method, the image processing unit 152 may generate an AF evaluation value. The image processing unit 152 stores the processed image data in the RAM 154.

In a case of recording image data stored in RAM 154, main control unit 151 generates a data file according to the recording format by, for example, adding a predetermined header to the image data. At this time, the main control unit 151 controls a compression/decompression unit 153 to compress the amount of information by encoding the image data as necessary. The main control unit 151 records the generated data file on a recording medium 157, such as a memory card.

Furthermore, in a case of displaying image data stored in the RAM 154, the main control unit 151 controls the image processing unit 152 to scale the image data so as to fit the display size of a display unit 150, and then writes the scaled image data to an area (VRAM area) of the RAM 154 used as a video memory. The display unit 150 reads out the image data for display from the VRAM area of the RAM 154, and displays the image data on a display device such as an LCD or an organic EL display.

The image capturing apparatus 100 of this embodiment causes the display unit 150 to function as an electronic viewfinder (EVF) by instantly displaying on the display unit 150 an image of each frame captured during standby for still image shooting or during moving image recording. The moving image (frame images) displayed when the display unit 150 functions as an EVF are called a live view image or a through image. In addition, in a case where a still image is shot by the image capturing apparatus 100, the image capturing apparatus 100 displays the shot still image on the display unit 150 for a certain period of time so that the user can check the shooting result. These display operations are also realized under the control of the main control unit 151.

An operation unit 156 includes operation members such as switches, buttons, keys, a touch panel, and a line-of-sight input device that allow a user to input instructions to the image capturing apparatus 100. An input through the operation unit 156 is detected by the main control unit 151 via the bus 160, and the main control unit 151 controls each part to realize an operation according to the input.

The main control unit 151 has one or more programmable processors such as a CPU or an MPU, and controls each unit by, for example, loading programs stored in a storage unit 155 into a RAM 154 and executing them, thereby realizing the functions of the image capturing apparatus 100. The main control unit 151 also executes AE processing to automatically determine exposure conditions (shutter speed or charge accumulation period, aperture value, and sensitivity) based on information about the luminance of the subject. The information about the luminance of the subject can be obtained, for example, from the image processing unit 152. The main control unit 151 can also determine the exposure conditions based on a specific area of the subject, such as a person's face, as a reference.

Of the determined exposure conditions, the main control unit 151 notifies the shooting control unit 143 of the charge accumulation period and sensitivity (gain), and also notifies the aperture value to the aperture control unit 105. The shooting control unit 143 controls the operation of the image sensor 141 so that shooting is performed according to the notified charge accumulation period, and sets the gain in the signal processing unit 142. In addition, the aperture control unit 105 actuates the aperture motor 104 to control the opening diameter of the aperture 103 so as to be the notified aperture.

Batteries 159 are managed by a power management unit 158, and supply power to the entire image capturing apparatus 100.

A storage unit 155 stores the programs executed by the main control unit 151, setting values required to execute the programs, GUI data, user setting values, weights and bias values learned by machine learning described below, etc. For example, when an instruction to transition from a power OFF state to a power ON state is given by operation of the operation unit 156, the programs stored in the storage unit 155 are loaded into part of the RAM 154, and the main control unit 151 executes the programs.

A depth information acquisition unit 161 calculates depth information from the pair of parallax image signals stored in the RAM 154, and stores the calculated depth information in the RAM 154.

The main subject determination unit 162 determines the main subject among the subjects detected in each captured frame image. The configuration and operation of the main subject determination unit 162 will be described in detail later. The result of determination by the main subject determination unit 162 is notified to each processing block via the bus 160.

The result of determination by the main subject determination unit 162 can be used, for example, for automatic setting of a focus detection area. As a result, a tracking AF function for a specific subject area can be realized. In addition, AE processing can be performed based on the luminance information of the focus detection area, and image processing (e.g., gamma correction processing, white balance adjustment processing, etc.) can be performed based on the pixel values of the focus detection area. In addition, the main control unit 151 may superimpose an index (e.g., a rectangular frame surrounding an area) representing the current main subject or an area indicating a subject or unique object detected by the main subject determination unit 162 through processing described later on the displayed image.

### Main Subject Determination Processing

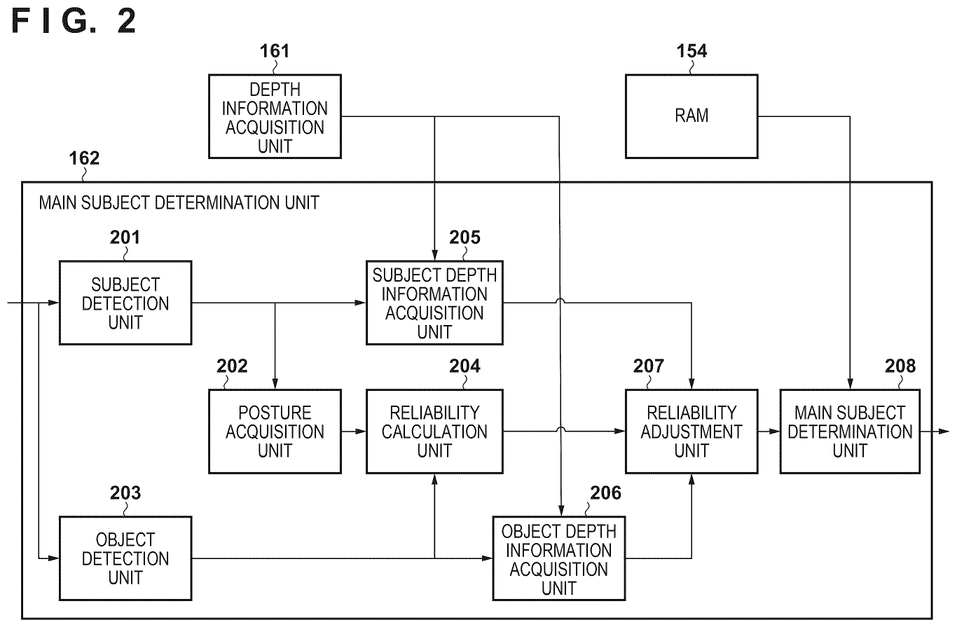

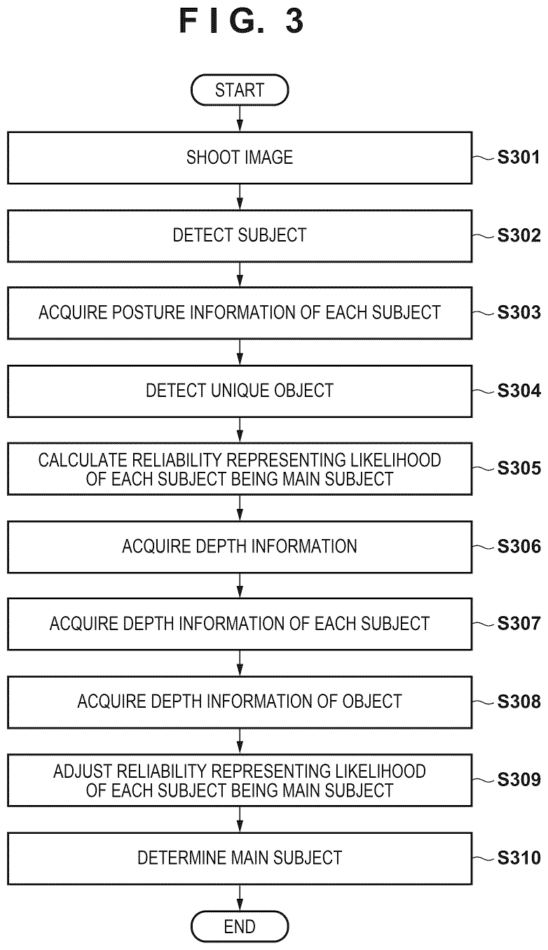

Next, the main subject determination processing in this embodiment will be described with reference to FIGS. 2 and 3.

FIG. 2 is a block diagram illustrating the functional configuration of the main subject determination unit 162, and FIG. 3 is a flowchart illustrating the main subject determination processing. Note that, unless otherwise specified, each process in this flowchart is realized by each part of the image capturing apparatus 100 operating under the control of the main control unit 151. Also, at the start of this flowchart, the image capturing apparatus 100 is powered on and in live view image shooting mode, and is in a state in which it is possible to instruct the start of shooting (recording) of a still image or moving image by operating the operation unit 156. Note that, in the following explanation, a ball game played by a plurality of people is described as a scene to be shot in the main subject determination processing, but scenes to be shot to which this embodiment can be applied are not limited to this.

First, in step S301, the main control unit 151 controls the shooting control unit 143 to perform shooting by the image sensor 141, and stores an image signal and a pair of parallax image signals A/D converted by the signal processing unit 142 in the RAM 154.

In step S302, a subject detection unit 201 of the main subject determination unit 162 detects a subject (person) in the image of the image signal acquired in step S301. Any known method may be used as the subject detection method, and for example, the subject may be detected using a feature extraction process of a specific subject by Convolutional Neural Networks (CNN), or the subject to be detected may be registered in advance as a template and detected by template matching.

In step S303, a posture acquisition unit 202 estimates a posture of each of the subjects detected by the subject detection unit 201, and acquires posture information. The contents of the posture information to be acquired are determined according to the type of the subject. In this example, since the subject is a person, the posture acquisition unit 202 acquires the positions of multiple joints of the person as posture information.

In step S304, an object detection unit 203 detects an object (hereinafter referred to as a “unique object”) that is unique to the scene on the image of the image signal acquired in step S301, and acquires the two-dimensional coordinates and size of the detected unique object in the image. The type of unique object to be detected is determined based on the scene to be shot, and since the scene to be shot is a ball game in this example, the object detection unit 203 detects a ball as the unique object.

Any known method may be used for object detection and posture estimation. For example, the methods described in Reference 1 (Redmon, Joseph, et al., “You only look once: Unified, real-time object detection.”, Proceedings of the IEEE conference on computer vision and pattern recognition, 2016) and Reference 2 (Cao, Zhe, et al., “Realtime multi-person 2d pose estimation using part affinity fields.”, Proceedings of the IEEE Conference on Computer Vision and Pattern Recognition, 2017) may be used.

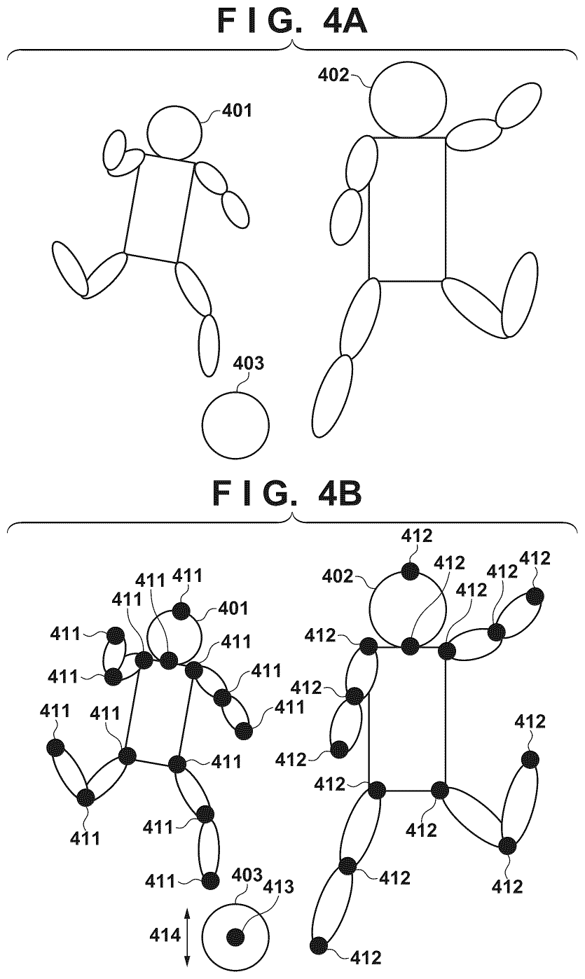

FIGS. 4A and 4B are conceptual diagrams of information acquired by the posture acquisition unit 202 and the object detection unit 203. FIG. 4A shows an example of an image to be processed, in which a subject 402 is about to kick a ball 403 and a subject 401 is about to interfere with the subject 402's kicking of the ball 403. The important subject in this scene is the subject 402 about to kick the ball. In this embodiment, the posture information of the subject and the information of the unique object are used to determine a main subject that is likely to be intended by the user as a target for image shooting control. On the other hand, the subject 401 is a non-main subject. Here, the non-main subject refers to a subject other than the main subject.

FIG. 4B is a diagram showing an example of posture information of the subject 401 and the subject 402, and the position and size of the ball 403. Joints 411 represent respective joints of the subject 401, and joints 412 represent respective joints of the subject 402. FIG. 4B shows an example in which the positions of the top of the head, the neck, the shoulders, the elbows, the wrists, the hip joints, the knees, and the ankles are acquired as joints, but the acquired joints may be some of these, or positions other than the joints may be acquired. In addition, the posture information may be information on axes connecting the joints, etc., in addition to the joint positions, and any information may be used as long as it represents the posture of the subject. In the following description, a case in which the joint positions are acquired as posture information will be described.

The posture acquisition unit 202 acquires the two-dimensional coordinates (x, y) of the joints 411 and 412 in the image. Here, the unit of (x, y) is a pixel. A center of gravity position 413 represents the center of gravity position of the ball 403, and an arrow 414 represents the size of the ball 403 in the image. The object detection unit 203 acquires the two-dimensional coordinates (x, y) of the center of gravity position of the ball 403 in the image, and the number of pixels indicating the diameter which is the size of the ball 403 in the image.

In step S305, a reliability calculation unit 204 calculates a reliability (probability) representing the likelihood of each subject being a main subject based on at least one of the coordinates of the joints acquired by the posture acquisition unit 202 and the coordinates and size of the unique object acquired by the object detection unit 203. This reliability corresponds to the degree of possibility that the subject is the main subject of the image to be processed. A method for calculating the reliability will be described later. In this embodiment, a case will be described in which the probability that the subject is the main subject of the image to be processed is used as the reliability representing the likelihood of the subject being a main subject, but a value other than the probability may be used. For example, the reciprocal of the distance between the center of gravity of the subject and the center of gravity of the unique object may be used as the reliability.

Here, a method for calculating the probability that represents the likelihood of a subject being a main subject based on the coordinates of each joint and the coordinates and size of a unique object, which is performed in the reliability calculation unit 204, will be described. In the following description, a case where a neural network, which is one method of machine learning, is used will be described.

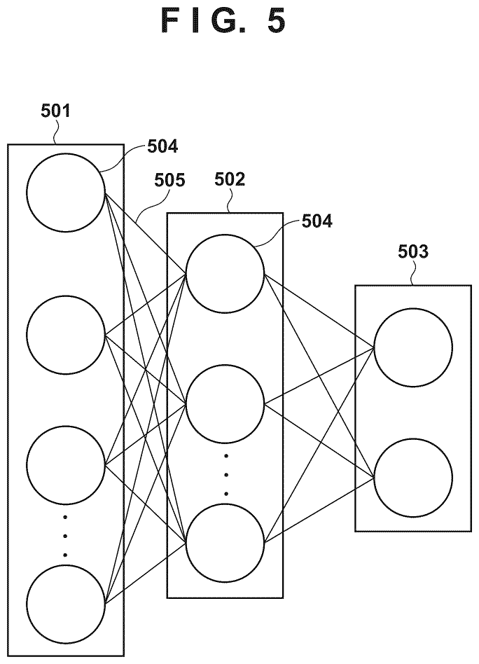

FIG. 5 is a diagram showing an example of the structure of a neural network. In FIG. 5, reference numeral 501 indicates an input layer; 502, an intermediate layer; 503, an output layer; 504, neurons; and 505, the connection relationship between the neurons 504. Here, for convenience of illustration, only representative neurons and connection lines are numbered. The number of neurons 504 in the input layer 501 is equal to the dimension of the input data, and the number of neurons in the output layer 503 is two. This corresponds to a two-class classification problem of determining whether or not the data represents the main subject.

A weight wji is assigned to a line 505 connecting the i-th neuron 504 in the input layer 501 and the j-th neuron 504 in the intermediate layer 502, and the value zⱼ output by the j-th neuron 504 in the intermediate layer 502 can be expressed by the following Equations (1) and (2).

$${z}_{j} = h ( {b}_{j} + {\sum }_{j} {w}_{j i} {x}_{i} ) \qquad ( 1 )$$

$$h ( z ) = max ( z , 0 ) \qquad ( 2 )$$

In the Equation (1), xᵢ represents the value input to the i-th neuron 504 in the input layer 501. The sum is taken for all neurons 504 in the input layer 501 that are connected to the j-th neuron. bⱼ is called the bias, and is a parameter that controls the ease with which the j-th neuron 504 fires. The function h defined by the Equation (2) is an activation function called Rectified Linear Unit (ReLU). As the activation function, it is also possible to use another function such as a sigmoid function.

Moreover, a value yₖ output by the k-th neuron 504 in the output layer 503 is given by the following Equations (3) and (4).

$${y}_{k} = f ( {b}_{k} + {\sum }_{j} {w}_{k j} {z}_{j} ) \qquad ( 3 )$$

$$f ( {y}_{k} ) = \frac{exp ( {y}_{k} )}{{\sum }_{i} exp ( {y}_{i} )} \qquad ( 4 )$$

In the Equation (3), zⱼ represents the value output by the j-th neuron 504 in the intermediate layer 502, where i, k=0, 1. 0 corresponds to a non-main subject, and 1 corresponds to a main subject. The sum is taken for all neurons in the intermediate layer 502 that are connected to the k-th neuron. Furthermore, the function f defined in the Equation (4) is called a softmax function, and outputs a probability value that belongs to the k-th class. In this embodiment, f(y₁) is used as the probability representing the likelihood of a subject being a main subject.

During learning, the coordinates of the joints of the subject and the coordinates and size of the unique object are input. Then, all weights and biases are optimized so as to minimize a loss function that uses the output probability and the correct label. Here, the correct label takes two values: “1” for the main subject and “0” for a non-main subject. As the loss function L, a binary cross-entropy as expressed by the following Equation (5) may be used.

$$L ( y , t ) = - {\sum }_{m} {t}_{m} log {y}_{m} - {\sum }_{m} ( 1 - {t}_{m} ) log ( 1 - {y}_{m} ) \qquad ( 5 )$$

In the Equation (5), the subscript m represents the index of the subject to be learned. yₘ is the probability value output from the neuron 504 with k=1 in the output layer 503, and tₘ is the correct label. The loss function may be any function other than the Equation (5) that can measure the degree of agreement with the correct label, such as the mean square error function. By optimizing the weights and biases based on the Equation (5), it is possible to determine the weights and biases so that the correct label and the output probability value approach each other.

The learned weights and bias values (learned data) are saved in advance in the storage unit 155, and are stored in the RAM 154 as necessary. A plurality of types of weights and bias values may be prepared depending on the scene. The reliability calculation unit 204 uses the learned weights and biases (the results of machine learning performed in advance) to output the probability value f(y₁) based on the Equations (1) to (4).

In addition, when learning, the state before moving on to an important action may be learned as the state of the main subject. For example, in the case of kicking a ball, the state of swinging the leg up to kick the ball can be learned as one of the states of the main subject. The reason for adopting this configuration is that the control of the image capturing apparatus 100 needs to be executed appropriately when the main subject actually performs an important action. For example, when the reliability (probability) corresponding to the main subject exceeds a preset threshold, the control to automatically record a still image or a moving image (recording control) is started, so that the user can capture an image of an important moment without missing it. In this case, information on the typical time taken from the state of the learned target to the important action may be used for the control of the image capturing apparatus 100.

Although the method for calculating the reliability (probability) using a neural network has been described above, other machine learning methods such as a support vector machine or a decision tree may be used as long as it is possible to classify whether a subject is a main subject or not. Also, without being limited to machine learning, a function that outputs the reliability or probability based on a certain model may be constructed.

In the scene shown in FIG. 4A, it is assumed that both subjects 401 and 402 are in a position with their leg swung up, there is no significant difference in their coordinate distance from the ball 403, and there is no significant difference in their detected reliability.

In step S306, the depth information acquisition unit 161 generates depth information using the pair of parallax image signals. The depth information is one piece of information about the distance in the depth direction of each pixel with reference to the position of the image capturing apparatus 100, and is also called a distance map, a depth map, a depth image, or a distance image. Note that the depth information may be generated without using the pair of parallax image signals. For example, the position of the focus lens 131 where the contrast evaluation value is maximized may be obtained for each pixel to generate depth information for each pixel.

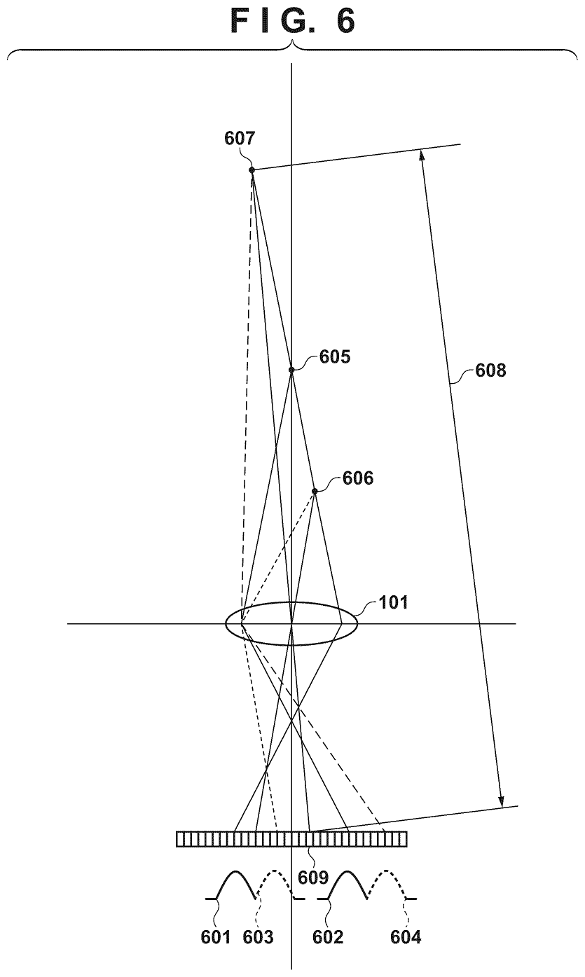

Here, using FIG. 6, a method for calculating distance information to a subject at each pixel will be explained as an example of depth information.

If an image A 601 and image B 602 are obtained, it can be seen that the light beam is refracted as shown by the solid line from the focal length of the imaging lens 101 and the distance information between the focus lens 131 and the image sensor 141. It can therefore be seen that the subject in focus is at position 605. Similarly, if the image A 601 and an image B 603 are obtained, it can be seen that the subject in focus is at position 606, and if the image A 601 and an image B 604 are obtained, it can be seen that the subject in focus is at position 607. As described above, for each pixel, distance information to the subject at that pixel position can be calculated from the relative position between an image A which includes that pixel and a corresponding image B.

For example, in FIG. 6, it is assumed that the image A 601 and the image B 604 are obtained. In this case, a distance 608 from a pixel 609 located at the midpoint, which corresponds to half the shift amount between the images, to a position 607, or a defocus amount corresponding to the distance 608, is stored as distance information for the pixel 609. In this manner, distance information can be obtained for each pixel, and depth information can be generated.

The depth information may be generated by dividing the image into minute regions and calculating the defocus amount for each minute region. In that case, images A and B are generated from pixels included in each minute region, and the phase difference (image shift amount) is detected by correlation calculation and converted into the defocus amount. In this case, too, the generated depth information indicates the distance information of each pixel, but pixels included in the same minute region have the same distance information. The depth information acquisition unit 161 supplies the generated depth information to a subject depth information acquisition unit 205 and an object depth information acquisition unit 206.

In the above description, the case where the defocus amount, which is distance information of subjects and object, is acquired as the depth information has been described in detail, but the present invention is not limited to this. As described above, the depth information may be a distance map, a depth map, a depth image, or a distance image. Further, for example, values that the defocus amounts atr normalized by the focal depth (e.g., 1Fδ, where F is the aperture value and δ is a diameter of the allowable circle of confusion) may be obtained as the depth information. Furthermore, the depth information may be, for example, an actual distance indicating the actual distance from the image capturing apparatus 100 to the subject, or information indicating the image shift amount used to derive the defocus amount.

The processes of steps S302 and S303, S304, and S306 may be performed in parallel.

Next, in step S307, the subject depth information acquisition unit 205 acquires depth information of each subject detected by the subject detection unit 201 using the depth information acquired by the depth information acquisition unit 161.

Furthermore, in step S308, the object depth information acquisition unit 206 acquires depth information of the unique object detected by the object detection unit 203 using the depth information acquired by the depth information acquisition unit 161.

Note that the processes of steps S307 and S308 may be performed in parallel.

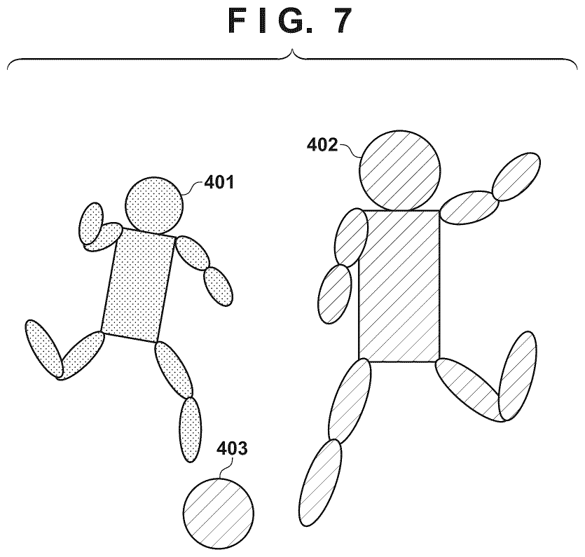

FIG. 7 is a conceptual diagram showing the results of applying processing by the subject depth information acquisition unit 205 and the object depth information acquisition unit 206 to the subjects 401 and 402 and the ball 403 in FIG. 4A. The diagonal lines and shading in FIG. 7 each represent distance information, with the diagonal lines indicating closer to the image capturing apparatus 100. The subject 402 has the same depth as the ball 403, and the subject 401 is further back (farther away from the image capturing apparatus 100) than the subjects 402 and the ball 403.

In step S309, a reliability adjustment unit 207 adjusts the reliabilities calculated by the reliability calculation unit 204 using the depth information acquired by the subject depth information acquisition unit 205 and the object depth information acquisition unit 206. For example, the reliabilities (probabilities) f(y₁) obtained using the Equations (1) to (4) are adjusted by multiplying them by a coefficient k corresponding to the absolute values of the differences between the distance information of the subjects and the distance information of the object.

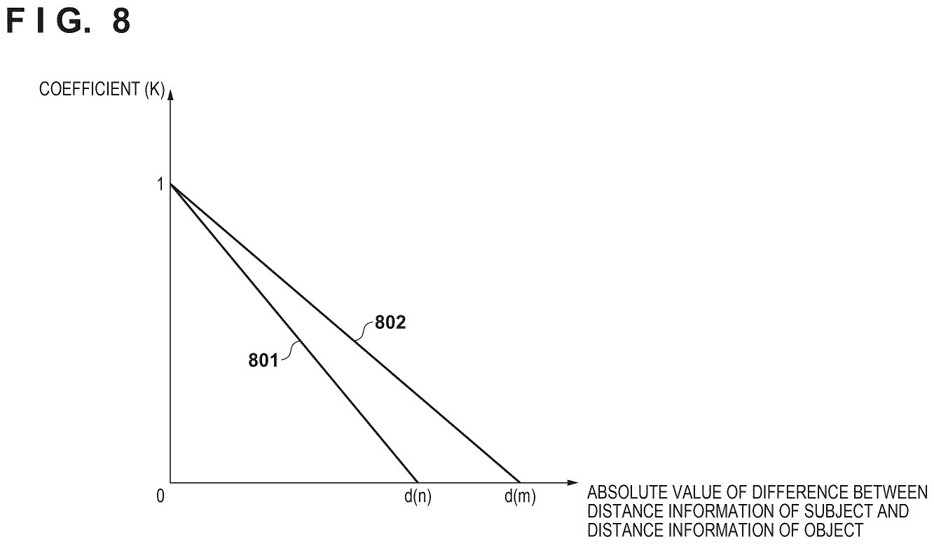

FIG. 8 is a graph showing the relationship between the coefficient (amount of change) and the absolute value of the difference between the distance information of a subject and the distance information of a unique object. As shown in FIG. 8, the coefficient takes a value between 0 and 1, and when the difference is 0, the coefficient k is set to 1, and as the difference increases, the coefficient k approaches 0, thereby decreasing the reliability (probability).

The slope of the graph may also be changed according to the distance between a unique object and a subject on the image. d(n) is the absolute value of the difference in distance information between the subject and the unique object in which the coefficient k is 0 when the distance between the subject and the unique object in the image is n, and the straight line 801 is the graph under such condition. Similarly, d(m) is the absolute value of the difference in distance information between the subject and the unique object in which the coefficient k is 0 when the distance between the subject and the unique object in the image is m, and the straight line 802 is the graph under such condition. In this embodiment, as the distance between the subject and the object in the image becomes shorter, the absolute value of the difference in distance information between the subject and the unique object when the coefficient k is 0 is increased to make the slope of the coefficient k gentler. In the example shown in FIG. 8, the distance is m<n.

Moreover, in a case where the reliability f(y₁) is equal to or greater than a predetermined threshold, the coefficient k may not be multiplied. Moreover, the threshold may be adjusted according to the absolute value of the difference in the distance information between the subject and the object.

In the present embodiment, the relationship between the coefficient and the absolute value of the difference in distance information between the subject and the object is described as a linear function (straight line), but it may be a logarithmic function or an exponential function. Also, in the present embodiment, the minimum value of the coefficient k is set to 0, but the minimum value may be set to a value greater than 0.

In the example shown in FIG. 7, the absolute value of the difference in distance information between the subject 402 and the ball 403 is smaller than that between the subject 401 and the ball 403, and therefore as a result of the reliability adjustment, the rate of decrease in the reliability of the subject 402 as the main subject is lower than the rate of decrease in the reliability of the subject 401 as the main subject.

In step S310, a main subject determination unit 208 determines the main subject of the image acquired in step S301 based on the reliabilities adjusted by the reliability adjustment unit 207, stores the main subject information of the determined main subject in the RAM 154, and ends the processing.

In a scene shown in FIG. 4A, it is assumed that the subject with the highest reliability is the subject 402 among the subjects whose reliabilities have been adjusted by the reliability adjustment unit 207. In this case, if the current main subject stored in the RAM 154 is the subject 401, the main subject is changed from the subject 401 to the subject 402 having the highest reliability.

In a case of changing the main subject, hysteresis may be provided, such as changing the main subject from the subject 401 to the subject 402 if the subject 402 has the highest reliability a predetermined number of times over time. In this case, the timing to change to the subject 402 is determined using past main subject information stored in the RAM 154. Also, the main subject may be changed if the distance in the coordinates between the current main subject and the subject with the highest reliability in the current frame image is constant. Also, the main subject may be changed using any chronological information.

As described above, according to the first embodiment, the image capturing apparatus 100 acquires posture information of each of the plurality of subjects detected from the image to be processed, a unique object, and depth information. The image capturing apparatus 100 then calculates a reliability, corresponding to the degree of likelihood that the subject is a main subject of the image to be processed, of each of the plurality of subjects based on the posture information and the unique object. The image capturing apparatus 100 then adjusts the calculated reliabilities using the depth information, thereby determining a main subject of the image to be processed from among the plurality of subjects based on the plurality of adjusted reliabilities of the plurality of subjects. This makes it possible to determine a main subject that is likely to meet the user's intention in an image containing a plurality of subjects.

In the above example, the main subject is determined for each frame image, but the determination may be performed every predetermined number of frame images.

### Second Embodiment

Next, a second embodiment of the present invention will be described. Note that the same reference numerals will be used for configurations and processes common to the first embodiment, and descriptions thereof will be omitted.

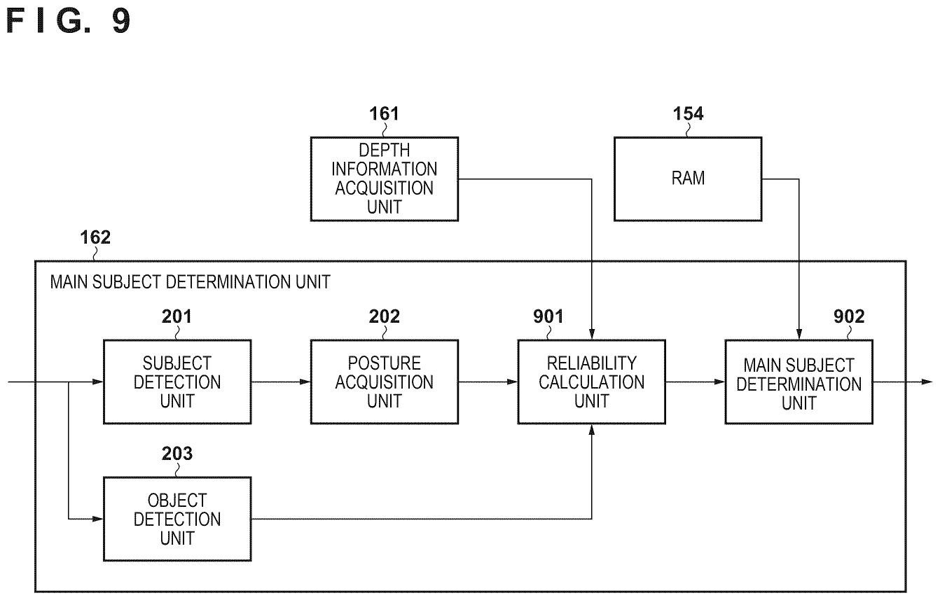

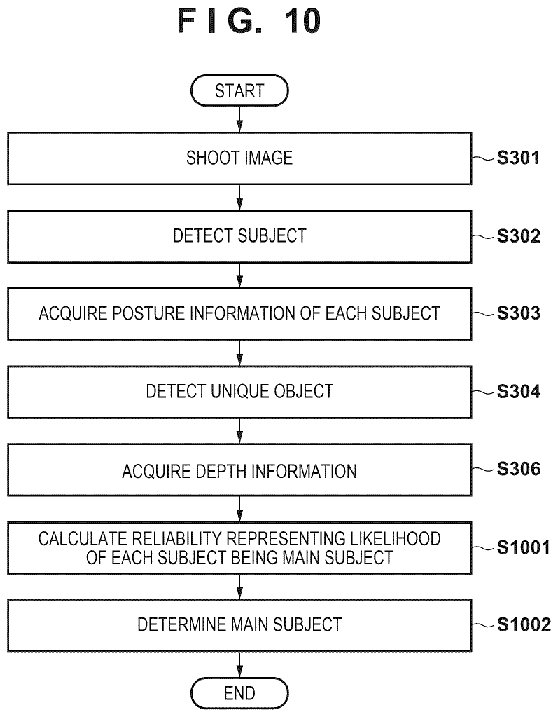

The second embodiment will be described with reference to FIGS. 9 and 10. FIG. 9 is a block diagram illustrating a functional configuration of main subject determination unit 162 in the second embodiment, and FIG. 10 is a flowchart of main subject determination processing in the second embodiment.

After acquiring depth information by the depth information acquisition unit 161 in step S306, in step S1001, a reliability calculation unit 901 calculates a reliability (probability) representing the likelihood of each subject being a main subject based on the coordinates of the joints estimated by the posture acquisition unit 202, and at least one of the coordinates and size of the unique object acquired by the object detection unit 203, and the depth information acquired by the depth information acquisition unit 161. The method of calculating the probability is the same as that described in the first embodiment, and therefore a description thereof will be omitted.

In the first embodiment, the coordinates of the joints of the subject and the coordinates and size of the unique object are used during learning, and the loss function L is optimized using based on the Equation (5). In contrast, in the second embodiment, depth information acquired by the depth information acquisition unit 161 is additionally input, and the loss function L is optimized based on the Equation (5).

In step S1002, a main subject determination unit 902 determines the main subject of the image acquired in step S301 based on the reliability calculated by the reliability calculation unit 901. Note that the main subject determination method is similar to that described in the first embodiment, and therefore description thereof will be omitted.

As described above, according to the second embodiment, by using depth information as an input of learning in advance, the image capturing apparatus 100 calculates a reliability, corresponding to the degree of likelihood that the subject is a main subject, for each of a plurality of subjects based on the posture information, unique object, and depth information. Then, based on the calculated plurality of reliabilities, the image capturing apparatus 100 determines a main subject from among the plurality of subjects in the image to be processed. This makes it possible to determine a main subject that is likely to meet the user's intention in an image containing a plurality of subjects.

### <Modification>

In the first and second embodiments described above, it has been explained that posture information of the detected subject is obtained without error and that an appropriate reliability is obtained. However, if the movement of the main subject intended by the photographer is large and fast, there is a possibility that posture information acquisition will fail and an appropriate reliability will not be obtained.

For example, in the scene shown in FIG. 4A, if the movement of the subject 402 is fast and posture information acquisition fails, the reliability of the subject 402 will be lower than that of the subject 401.

In this modification, as a process to deal with such a case, if the subject 402 is stored as the main subject in the history of main subjects stored in the RAM 154 and the subject 401 is selected as the main subject based on the reliability, the following determination is made. That is, the absolute value of the difference in the distance information between the subject 401 and the ball 403 is compared with a threshold. Then, if the absolute value of the difference is equal to or greater than the threshold, the subject 402 is maintained as the main subject regardless of the reliability, and if it is smaller than the threshold, the main subject is changed to the subject 401.

By controlling in this way, even if acquisition of posture information fails, frequent changes of the main subject can be prevented.

### OTHER EMBODIMENTS

The present invention may be applied to a system made up of a plurality of devices, or to an apparatus made up of a single device.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-027866, filed Feb. 27, 2024 which is hereby incorporated by reference herein in its entirety.

What is claimed is:

1. An electronic apparatus comprising one or more processors and/or circuitry which function as:
a first detection unit that detects one or more subjects from any of images obtained by repeatedly performing shooting;
a second detection unit that detects a predetermined object from the image from which the subject/subjects are detected;
a determination unit that determines a reliability indicating a degree of possibility of a subject being a main subject based on a posture of each subject detected by the first detection unit;
an adjustment unit that adjusts the reliability based on a difference between information about a distance to each of the subjects in a depth direction and information about a distance to the object in a depth direction; and
a decision unit that decides, based on the reliability adjusted by the adjustment unit, one of the subject/subjects detected by the first detecting unit as a main subject.

2. The electronic apparatus according to claim 1, wherein the adjustment unit reduces a decrease in the reliability in a case where the difference is a first value, compared to a case where the difference is a second value that is greater than the first value.

3. The electronic apparatus according to claim 2, wherein the adjustment unit reduces a rate of decrease according to the difference in a case where a distance in the image between each of the subjects and the object is a first distance, compared to a case where the distance in the image is a second distance that is greater than the first distance.

4. The electronic apparatus according to claim 1, wherein the adjustment unit does not adjust the reliability in a case where the reliability is equal to or greater than a predetermined threshold.

5. The electronic apparatus according to claim 1, wherein the adjustment unit adjusts the reliability by multiplying the reliability by a coefficient determined based on the difference, and
the coefficient is equal to or greater than 0 and equal to or less than 1.

6. The electronic apparatus according to claim 5, wherein the coefficient is defined by any one of a linear function, a logarithmic function, and an exponential function of the difference.

7. The electronic apparatus according to claim 1, wherein the adjustment unit obtains information about a distance in a depth direction for each pixel of the image, and obtains information about a distance to each of the subjects and a distance to the object based on the obtained information about the distance for each pixel.

8. The electronic apparatus according to claim 1, wherein the adjustment unit obtains information about a distance in a depth direction for each of a plurality of regions obtained by dividing the image, and obtains information about the distance to each of the subjects and a distance to the object based on the obtained information about the distance for each region.

9. The electronic apparatus according to claim 1, wherein the information about the distance includes a defocus amount, a value obtained by normalizing the defocus amount by a focal depth, a distance from the electronic apparatus, and an image shift amount.

10. The electronic apparatus according to claim 1, wherein the determination unit determines the reliability by machine learning.

11. The electronic apparatus according to claim 10, wherein the machine learning includes a neural network that is trained on the subject, a support vector machine, and a decision tree.

12. The electronic apparatus according to claim 1, wherein the one or more processors and/or circuitry further function as a storage unit that stores the main subject determined by the determination unit, and
the decision unit selects one of the subjects detected by the first detection unit as a main subject based on the reliability, and determines the main subject based on the selected main subject and a history of main subjects stored in the storage unit.

13. The electronic apparatus according to claim 12, wherein, in a case where a main subject stored in the storage unit is detected by the first detection unit and the stored main subject is different from the selected main subject, the decision unit decides the main subject stored in the storage unit as the main subject if a difference in information about a distance in a depth direction between the selected main subject and the object is greater than a difference in a distance in a depth direction between the main subject stored in the storage unit and the object.

14. The electronic apparatus according to claim 12, wherein, in a case where a main subject stored in the storage unit is detected by the first detection unit and the stored main subject is different from the selected main subject, the decision unit determines the selected subject as the main subject if the same subject is selected as the main subject a predetermined number of times in succession.

15. The electronic apparatus according to claim 1, wherein the predetermined object is determined according to a scene to be shot.

16. The electronic apparatus according to claim 1 further comprising an image shooting unit that shoots the images.

17. An electronic apparatus comprising one or more processors and/or circuitry which function as:
a first detection unit that detects one or more subjects from any of images obtained by repeatedly performing shooting;
a second detection unit that detects a predetermined object from the image from which the subject/subjects are detected;
a decision unit that decides one of the subject/subjects detected by the first detection unit as a main subject based on a posture of each subject detected by the first detection unit and a difference between information about a distance to each subject in the depth direction and information about a distance to the object in the depth direction.

18. The electronic apparatus according to claim 17, wherein the information about the distances to each subject and the object is obtained, by obtaining information about the distance in the depth direction for each pixel of the image, based on the obtained information about the distance for each pixel.

19. The electronic apparatus according to claim 17, wherein the information about the distances to each subject and the object is obtained, by obtaining information about the distance in the depth direction for each of a plurality of regions obtained by dividing the image, based on the obtained information about the distance for each region.

20. The electronic apparatus according to claim 17, wherein the information about the distance includes a defocus amount, a value obtained by normalizing the defocus amount by a focal depth, a distance from the electronic apparatus, and an image shift amount.

21. The electronic apparatus according to claim 17, wherein the predetermined object is determined according to a scene to be shot.

22. The electronic apparatus according to claim 17 further comprising an image shooting unit that shoots the images.

23. An electronic apparatus comprising one or more processors and/or circuitry which function as:
a first detection unit that detects one or more subjects from any of images obtained by repeatedly performing shooting;
a second detection unit that detects a predetermined object from the image from which the subject/subjects are detected;
an acquisition unit that acquires information regarding a distance in the depth direction to each subject detected by the first detection unit and information about a distance in the depth direction to the object;
a determination unit that uses machine learning to determine a reliability indicating a degree of possibility of a subject being a main subject based on a posture of each subject; and
a decision unit that decides one of the subject/subjects detected by the first detection unit as a main subject based on the reliability,
wherein the determination unit uses training data optimized by using information about the distance to the main subject previously acquired by the acquisition unit in the machine learning.

24. The electronic apparatus according to claim 23, wherein the one or more processors and/or circuitry further functions as a learning unit that optimizes the training data to be used in the machine learning by using the information about the distance acquired by the acquisition unit.

25. The electronic apparatus according to claim 23, wherein the one or more processors and/or circuitry further functions as a storage unit that stores the main subject decided by the decision unit,
wherein the decision unit selects one of the subject/subjects detected by the first detection unit as a main subject based on the reliability, and decides the main subject based on the selected main subject and a history of main subjects stored in the storage unit.

26. The electronic apparatus according to claim 25, wherein, in a case where a main subject stored in the storage unit is detected by the first detection unit and the stored main subject is different from the selected main subject, the decision unit decides the main subject stored in the storage unit as the main subject if a difference in information about a distance in a depth direction between the selected main subject and the object is greater than a difference in a distance in a depth direction between the main subject stored in the storage unit and the object.

27. The electronic apparatus according to claim 25, wherein, in a case where a main subject stored in the storage unit is detected by the first detection unit and the stored main subject is different from the selected main subject, the decision unit decides the selected subject as the main subject if the same subject is selected as the main subject a predetermined number of times in succession.

28. The electronic apparatus according to claim 23, wherein the predetermined object is determined according to a scene to be shot.

29. The electronic apparatus according to claim 23 further comprising an image shooting unit that shoots the images.

30. An image processing method comprising:
detecting one or more subjects from any of images obtained by repeatedly performing shooting;
detecting a predetermined object from the image from which the subject/subjects are detected;
determining a reliability indicating a degree of possibility of a subject being a main subject based on a posture of each detected subject;
adjusting the reliability based on a difference between information about a distance to each of the subjects in a depth direction and information about a distance to the object in a depth direction; and
deciding, based on the adjusted reliability, one of the detected subject/subjects as a main subject.

31. An image processing method comprising:
detecting one or more subjects from any of images obtained by repeatedly performing shooting;
detecting a predetermined object from the image from which the subject/subjects are detected;
determining one of the detected subject/subjects as a main subject based on a posture of each detected subject and a difference between information about a distance to each subject in the depth direction and information about a distance to the object in the depth direction.

32. An image processing method comprising:
detecting one or more subjects from any of images obtained by repeatedly performing shooting;
detecting a predetermined object from the image from which the subject/subjects are detected;
acquiring information regarding a distance in the depth direction to each detected subject detected and information regarding a distance in the depth direction to the object;
determining a reliability indicating a degree of possibility of a subject being a main subject based on a posture of each subject by using machine learning; and
deciding one of the detected subject/subjects as a main subject based on the reliability,
wherein training data optimized by using information about the distance to the main subject previously acquired is used in the machine learning.

33. A non-transitory computer-readable storage medium, the storage medium storing a program that is executable by the computer, wherein the program includes program code for causing the computer to function as an electronic apparatus comprising:
a first detection unit that detects one or more subjects from any of images obtained by repeatedly performing shooting;
a second detection unit that detects a predetermined object from the image from which the subject/subjects are detected;
a determination unit that determines a reliability indicating a degree of possibility of a subject being a main subject based on a posture of each subject detected by the first detection means;
an adjustment unit that adjusts the reliability based on a difference between information about a distance to each of the subjects in a depth direction and information about a distance to the object in a depth direction; and
a decision unit that decides, based on the reliability adjusted by the adjustment unit, one of the subject/subjects detected by the first detecting unit as a main subject.

34. A non-transitory computer-readable storage medium, the storage medium storing a program that is executable by the computer, wherein the program includes program code for causing the computer to function as an electronic apparatus comprising:
a first detection unit that detects one or more subjects from any of images obtained by repeatedly performing shooting;
a second detection unit that detects a predetermined object from the image from which the subject/subjects are detected;
a decision unit that determines one of the subject/subjects detected by the first detection unit as a main subject based on a posture of each subject detected by the first detection unit and a difference between information about a distance to each subject in the depth direction and information about a distance to the object in the depth direction.

35. A non-transitory computer-readable storage medium, the storage medium storing a program that is executable by the computer, wherein the program includes program code for causing the computer to function as an electronic apparatus comprising:
a first detection unit that detects one or more subjects from any of images obtained by repeatedly performing shooting;
a second detection unit that detects a predetermined object from the image from which the subject/subjects are detected;
an acquisition unit that acquires information regarding a distance in the depth direction to each subject detected by the first detection unit and information regarding a distance in the depth direction to the object;
a determination unit that uses machine learning to determine a reliability indicating a degree of possibility of a subject being a main subject based on a posture of each subject; and
a decision unit that decides one of the subject/subjects detected by the first detection unit as a main subject based on the reliability,
wherein the determination unit uses training data optimized by using information about the distance to the main subject previously acquired by the acquisition unit in the machine learning.
